(19) United States
(12) Patent Application Publication
(10) Pub. No.: US 2009/0322876 A1
(43) Pub. Date: Dec. 31, 2009

(54) CCTV MANAGEMENT SYSTEM SUPPORTING EXTENDED DATA TRANSMISSION COVERAGE THROUGH WIRELESS LAN

(75) Inventors: Joo-Hyeong Lee, Seoul (KR); Seung-Ho Kim, Gunpo-si (KR)

Correspondence Address: MCDERMOTT WILL & EMERY LLP, 600 13TH STREET, N.W., WASHINGTON, DC, 20005-3096, US

(73) Assignee: SDC MICRO INC.

(21) Appl. No.: 12/492,719

(22) Filed: Jun. 26, 2009

(30) Foreign Application Priority Data
Jun. 26, 2008 (KR) 10-2008-0061212

(51) Int. Cl. H04N 7/18

(52) U.S. Cl. 348/143; 348/E07.085

(57) ABSTRACT

Disclosed is a management system of an area to be photographed using a plurality of CCTVs, and more particularly to, a CCTV management system supporting an extended data transmission coverage with a wireless LAN, in which a plurality of CCTVs are installed in an area to be photographed and are collectively managed, that can be installed easier than a wired CCTV management system and can remove a limit to the data transmission coverage of a wireless CCTV management system by sequentially transmitting data photographed by the CCTVs in accordance with the access order of distances so that data photographed by a CCTV and data photographed by the other CCTVs are encoded and transmitted.

### BACKGROUND OF THE INVENTION

1. Field of the Invention

The present invention relates to a management system of an area to be photographed using a plurality of closed-circuit televisions (CCTVs), and more particularly to, a CCTV management system supporting an extended data transmission coverage with a wireless LAN, in which a plurality of CCTVs are installed in an area to be photographed and are collectively managed, that can be installed easier than a wired CCTV management system and can remove a limit to the data transmission coverage of a wireless CCTV management system by sequentially transmitting data photographed by the CCTVs in accordance with the access order of distances so that data photographed by a CCTV and data photographed by the other CCTVs are encoded and transmitted.

2. Description of the Related Art

In general, in a large city, CCTVs are installed and managed for purposes of monitoring public security, crime, patrol, illegal garbage abandonment, and illegal parking. However, the CCTVs are not entirely installed in the large city but are limitedly managed in some self-governing bodies. For example, in Gangnam-gu, Seoul, Korea, fixed CCTVs are installed and managed in alleys for purposes of public security. In Seoul city, CCTVs are installed along roads and are managed for the purpose of monitoring illegal parking. In addition, in ward offices, in order to monitor illegal garbage abandonment, CCTVs are provided in some areas and are managed.

FIG. 1 is a block diagram of an existing wired CCTV management system.

A CCTV transmits photographed data in a wire or wireless type. In the case of the wired CCTV, as illustrated in FIG. 1, the photographed data are wiredly transmitted to a set-top box or a personal computer (PC) in a state where images are not compressed so that a plurality of images are simultaneously displayed. In the case of the wireless CCTV, cameras directly transmit image data to an access point. In this case, the transmission distance of data is equal to the distance by which the data is transmitted and received from the cameras and the access point. In general, since a wireless LAN transmits data by the distance of 10m to 100m, a wireless camera that uses the wireless LAN transmits and receives data within this coverage.

Therefore, the installation of the wired CCTVs is complicated as the coverage to be photographed is larger and the number of CCTVs to be installed is larger. In the case of the wireless CCTV, when the coverage of an object to be photographed deviates from the coverage of 100m due to the limit to data transmission coverage, an access point is to be additionally provided so that the CCTV management system becomes more complicated and installation cost increases.

### BRIEF SUMMARY OF THE INVENTION

The present invention has been made in view of the above problems, and the present invention provides a CCTV management system supporting an extended data transmission coverage with a wireless LAN, in which a plurality of CCTVs are installed in an area to be photographed and are collectively managed, that can be installed easier than a wired CCTV management system and can remove a limit to the data transmission coverage of a wireless CCTV management system by sequentially transmitting data photographed by the CCTVs in accordance with the access order of distances so that data photographed by a CCTV and data photographed by the other CCTVs are encoded and transmitted.

In accordance with an embodiment of the present invention, there is provided a closed-circuit television (CCTV) management system in which a plurality of wireless LAN transmission type CCTVs are installed in preset positions so that photographed data thereof are received and are collectively managed. The CCTV management system includes: a plurality of CCTVs installed within coverage of an object to be photographed and managed and having wireless LAN modules to wirelessly transmit and receive photographed data; an access point receiving the photographed data from the CCTVs; a packet demultiplexer receiving the photographed data from the access point to generate compressed image data obtained by removing header data from the photographed data; an image decoder receiving the compressed image data from the packet demultiplexer to decode the compressed image data; and a display receiving the decoded image data from the image decoder to output the decoded image data. The plurality of CCTVs sequentially transmit the photographed data in an order set in accordance with a distance and mix the photographed data received during transmission with data photographed by a corresponding CCTV to transmit mixed data.

Each of the CCTVs includes a camera module photographing a target object, an image encoder compressing the photographed data transmitted from the camera module, a packet multiplexer receiving the compressed image data from the image encoder to give the header data, a packet demultiplexer removing the header data from the photographed data transmitted from a previous CCTV as the image data are transmitted in a set order to extract the compressed image data and to transmit the compressed image data to the packet multiplexer so that the corresponding image data and the image data of the previous CCTV are mixed with each other by the packet multiplexer, and a wireless LAN module transmitting the mixed image data transmitted from the packet multiplexer to a next CCTV in accordance with the set order and for receiving the mixed image data from the previous CCTV to transmit the received mixed image data to the packet demultiplexer.

The header data by the packet multiplexer includes addresses of next CCTVs to be transmitted in the set order.

According to the present invention, since cable construction work is not necessary unlike in an existing wired CCTV camera, installation may be easily performed, installation cost is reduced, and a limit to the transmission distance of data using a wireless LAN can be removed. Therefore, the CCTV management system may be established within larger coverage.

### BRIEF DESCRIPTION OF THE DRAWINGS

The objects, features and advantages of the present invention will be more apparent from the following detailed description in conjunction with the accompanying drawings, in which:

FIG. 1 is a block diagram of an existing wired CCTV management system;

FIG. 2 is a schematic block diagram of a CCTV management system according to an embodiment of the present invention;

FIGS. 3 to 5 are views illustrating the packet of CCTV 1, CCTV 2, . . . , and CCTV n;

FIG. 6 is a view illustrating a period to be photographed of the CCTV management system according to the embodiment of the present invention; and

FIG. 7 is a block diagram illustrating the internal structure of a CCTV according to the embodiment of the present invention.

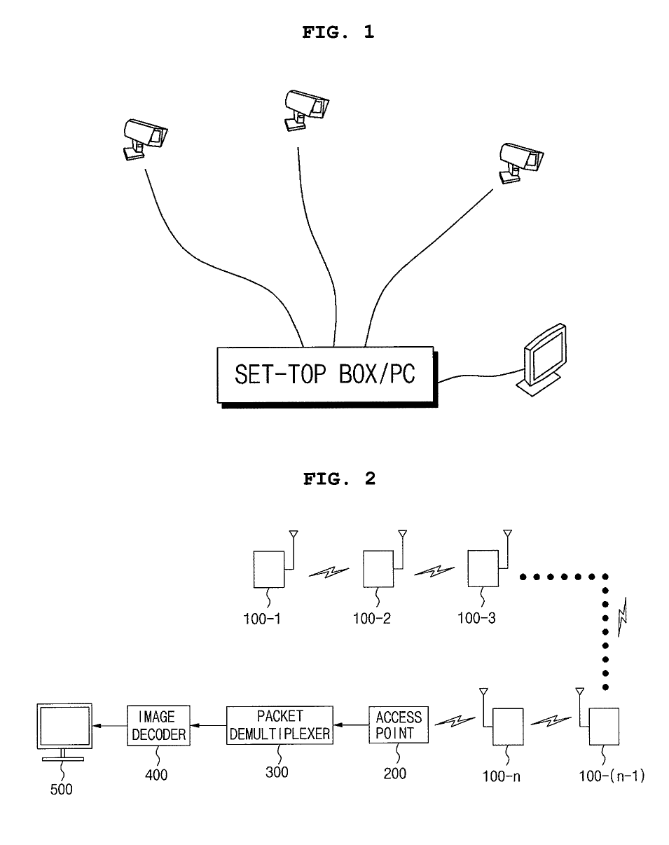

### DETAILED DESCRIPTION OF THE INVENTION

Hereinafter, a closed-circuit television (CCTV) management system according to an embodiment of the present invention will be described in detail with reference to the accompanying drawings.

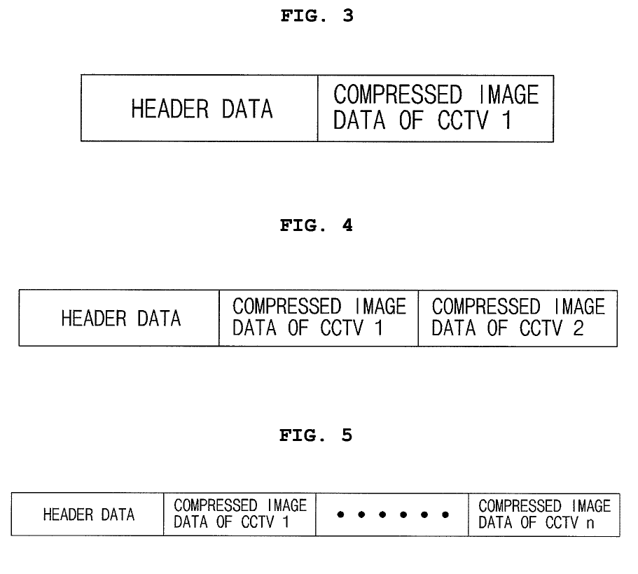

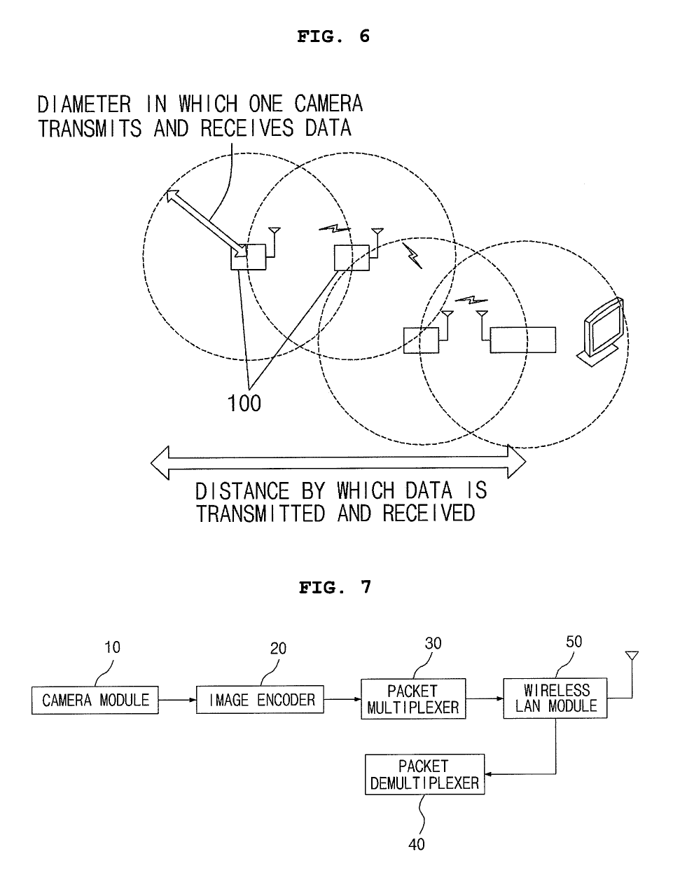

FIG. 2 is a schematic block diagram of a CCTV management system according to an embodiment of the present invention. FIGS. 3 to 5 are views illustrating the packet of CCTV 1, CCTV 2, . . . , and CCTV n. FIG. 6 is a view illustrating a period to be photographed of the CCTV management system according to the embodiment of the present invention. FIG. 7 is a block diagram illustrating the internal structure of a CCTV according to the embodiment of the present invention.

Referring to the drawings, the CCTV management system according to the embodiment of the present invention is installed within the coverage to be largely photographed and managed, and includes a plurality of CCTVs 100 in which wireless LAN modules 50 are mounted so that photographed data are wirelessly transmitted and received, an access point 200 receiving the photographed data from the CCTVs 100, a packet demultiplexer 300 receiving the photographed data from the access point 200 to generate compressed image data obtained by removing header data from the photographed data, an image decoder 400 receiving the compressed image data from the packet demultiplexer 300 to decode the compressed image data, and a display 500 receiving decoded image data from the image decoder 400 to output the decoded image data.

The CCTV 100 includes a camera module 10 photographing an object, an image encoder 20 compressing the photographed data transmitted from the camera module 10, a packet multiplexer 30 receiving the compressed image data from the image encoder 20 to give the header data, a packet demultiplexer 40 removing the header data from the photographed data transmitted from a previous CCTV 100 as the image data are transmitted in a set order to extract the compressed image data and to transmit the compressed image data to the packet multiplexer 30 so that the corresponding image data and the image data of the previous CCTV 100 are mixed with each other by the packet multiplexer 30, and a wireless LAN module 50 transmitting the mixed image data transmitted from the packet multiplexer 30 to a next CCTV 100 in accordance with the set order and receiving the mixed image data from the previous CCTV 100 to transmit the received mixed image data to the packet demultiplexer 40.

In general, in the case of the management system in which the plurality of CCTVs 100 is installed, image data are received from the CCTVs 100 to a management terminal so that the image data are output and controlled. According to the present invention, in accordance with a distance, a setting up order is determined so that the closest CCTV 100 comes first. Therefore, the image data of the remotest CCTV 100 is transmitted to the next CCTV 100 to be mixed with the image data of the next CCTV 100 and are transmitted to the next next CCTV again.

As a result, the image data of all the CCTVs 100 are extracted by the last CCTV 100 as one mixing data and are transmitted to the access point 200 so that the limit to the transmission distance of the CCTV management system using the wireless LAN may be overcome.

Here, the mixture processes of the CCTVs 100 will be described with reference to FIG. 2. First, the image data photographed and compressed by the camera module 10 of the CCTV 1 100-1 remotest from the access point 200 is transmitted to the CCTV 2 100-2 closest to the CCTV 1 100-1 through the wireless LAN module 50.

At this time, as illustrated in FIG. 3, the packet data transmitted from the CCTV 1 100-1 to the CCTV 2 100-2 containing the header data and the compressed image data of CCTV 1 100-1. The header data includes the address of the CCTV 2 100-2 so that the other CCTVs and the access point 200 do not receive data but only the CCTV 2 100-2 may receive the packet data of the CCTV 1 100-1.

The CCTV 2 100-2 adds the image data photographed and compressed by the camera module 10 thereof to the compressed image data received from the CCTV 1 100-1 to transmit the packet illustrated in FIG. 4 to still another CCTV 3 100-3 closest in the setting up order through the wireless LAN module 50. At this time, the header data includes the address of the CCTV 3 100-3 so that the other CCTVs and the access point 200 do not receive data but only the CCTV 3 100-3 may receive data.

By doing so, the CCTV n 100-n closet to the access point 200 adds the image data compressed thereby to the compressed image data received from the immediately previous CCTV n−1 100-(n−1) to finally transmit the packet illustrated in FIG. 5 to the access point 200 through the wireless LAN module 50.

A receiver of the access point 200 receives packet data from the CCTV n 100-n. The image decoder 400 decodes the compressed image data of the CCTV n 100-n from the CCTV 1 100-1 to transmit the decoded image data to the display 500.

FIG. 6 illustrates data transmission and reception distance according to the embodiment of the present invention. In general, since the wireless LAN transmits data by the distance of 10m to 100m, the CCTV 100 that uses a common wireless LAN cannot deviate from the coverage. However, according to the embodiment of the present invention, the plurality of CCTVs 100 are installed with the quality allowance coverage of moving image data so that data transmitting distance may be increased.

For example, when it is assumed that the CCTVs 100 compress the moving image data by QCIF (176*144), 15 fps to transmit data by 384 kbps, the amount of data that can be transmitted by the wireless LAN of 54 Mbps (IEEE 802.11g) is the data of about 140 (54 Mbps/384 kbps) CCTVs. Therefore, when the diameter of the data that is transmitted by the CCTVs 100 is 10m, the data transmission distance may be extended to about 1.4 km.

As illustrated in FIG. 7, the CCTV 100 includes a camera module 10, an image encoder 20, a packet multiplexer 30, a packet demultiplexer 40, and a wireless LAN module 50. The image data photographed by the camera module 10 is compressed by the image encoder 20 in order to transmit a large amount of image data. The compressed data is combined with the header data by the packet multiplexer 30 so that the packet illustrated in FIG. 3 is created.

At this time, as described above, the header data includes the address of the CCTV 2 100-2 so that the other CCTVs and the access point 200 do not receive data but only the CCTV 2 100-2 may receive the packet. The packet of FIG. 3 is transmitted to the CCTV 2 100-2 through the wireless LAN module 50.

In the case of the first CCTV 1 100-1, the packet demultiplexer 40 is not driven. In the case of the CCTV 2 100-2 to the CCTV n 100-n, only the image data compressed by the packet demultiplexer 40 is extracted from the packet received from the previous CCTV 100 and is transmitted to the packet multiplexer 30.

Therefore, the packet multiplexer 30 mixes the compressed image data transmitted from the image encoder 20, the header data, and the compressed image data extracted from the previous CCTV 100 with each other to obtain the packet illustrated in FIG. 4.

On the other hand, the CCTV n 100-n combines the compressed image data received from the CCTV n−1 100-(n−1) to form the packet illustrated in FIG. 5. The header data includes the address of the access point 200 so that only the access point 200 may receive the packet.

The packet data received from the CCTV n 100-n is transmitted to the packet demultiplexer 300. Here, the packet demultiplexer 300 performs the same function as the packet demultiplexer 40 in the above-described CCTV 100.

Therefore, the packet demultiplexer 300 transmits the extracted compressed image data obtained by removing the header data from the packet data of the CCTV n 100-n to the image decoder 400. The image decoder 400 decodes the compressed image data from the CCTV 1 100-1 to the CCTV n 100-n and transmits the decoded image data to the display. The display such as a monitor and a touch screen outputs the decoded image data. Therefore, a management worker can observe the coverage to be photographed.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A closed-circuit television (CCTV) management system in which a plurality of wireless LAN transmission type CCTVs are installed in preset positions so that photographed data thereof are received and are collectively managed, the CCTV management system comprising:
a plurality of CCTVs installed within coverage of an object to be photographed and managed and including wireless LAN modules to wirelessly transmit and receive photographed data;
an access point receiving the photographed data from the CCTVs;
a packet demultiplexer receiving the photographed data from the access point to generate compressed image data obtained by removing header data from the photographed data;
an image decoder receiving the compressed image data from the packet demultiplexer to decode the compressed image data; and
a display receiving the decoded image data from the image decoder to output the decoded image data;
wherein the plurality of CCTVs sequentially transmit the photographed data in an order set in accordance with a distance and mix the photographed data received during transmission with data photographed by a corresponding CCTV to transmit mixed data.

2. The CCTV management system of claim 1, wherein each of the CCTVs comprises:
a camera module photographing a target object;
an image encoder compressing the photographed data transmitted from the camera module;
a packet multiplexer receiving the compressed image data from the image encoder to give the header data;
a packet demultiplexer removing the header data from the photographed data transmitted from a previous CCTV as the image data are transmitted in a set order to extract the compressed image data and to transmit the compressed image data to the packet multiplexer so that the corresponding image data and the image data of the previous CCTV are mixed with each other by the packet multiplexer; and
a wireless LAN module transmitting the mixed image data transmitted from the packet multiplexer to a next CCTV in accordance with the set order and receiving the mixed image data from the previous CCTV to transmit the received mixed image data to the packet demultiplexer.

3. The CCTV management system of claim 2, wherein the header data given by the packet multiplexer includes addresses of next CCTVs to be transmitted in the set order.
